(19) United States
(12) Patent Application Publication
(10) Pub. No.: US 2008/0158480 A1
(43) Pub. Date: Jul. 3, 2008

(54) Photo-luminescence color liquid crystal display

(75) Inventors: Yi-Qun Ii, Danville, CA (US); Yi Dong, Tracy, CA (US); Wei Shan, Fremont, CA (US)

Correspondence Address: BUCHANAN, INGERSOLL & ROONEY PC, POST OFFICE BOX 1404, ALEXANDRIA, VA, 22313-1404, US

(73) Assignee: Intematix Corporation, Fremont, CA (US)

(21) Appl. No.: 11/906,540

(22) Filed: Oct. 1, 2007

Related U.S. Application Data
(63) Continuation-in-part of application No. 11/824,979, filed on Jul. 3, 2007.
(60) Provisional application No. 60/819,420, filed on Jul. 6, 2006.

(51) Int. Cl. G02F 1/1333

(52) U.S. Cl. 349/71

(57) ABSTRACT

A photo-luminescence liquid crystal display 100 comprises: a display panel 104 and a radiation source 102 (blue or UV LED) for generating excitation radiation for operating the display. The display panel 104 comprises transparent front 110 and back 112 plates; a liquid crystal (LC) 114 disposed there between; and a matrix of electrodes 120 (array of thin film transistors) defining red, green and blue pixel areas of the display and operable to selectively induce an electric field across the liquid crystal 114 in the pixel areas for controlling transmission of light through the pixels areas. Red 130 and green 132 phosphor materials are provided on the back plate corresponding to the red and green pixel areas and respectively emit red (R) and green (G) light in response to the excitation radiation. The LCD can further comprise a blue phosphor material 134 on the back plate corresponding to blue pixel areas.

### CROSS REFERENCE TO RELATED APPLICATION

This Application is a continuation-in-part of U.S. Utility application Ser. No. 11/824,979 filed Jul. 3, 2007 which claims the benefit of priority to U.S. Provisional Application No. 60/819,420 filed Jul. 6, 2006, the specification and drawings of both of which are incorporated herein by reference.

### BACKGROUND OF THE INVENTION

1. Field of the Invention

The present invention relates to the field of color displays, such as flat panel displays and color liquid crystal displays (LCDs), which convert electrical signals into color images. In particular, the invention concerns color, transmissive LCDs in which phosphor, photo-luminescent, materials are used to generate color light in response to excitation radiation from a backlight, such displays being termed photo-luminescence color LCDs or photo-luminescent color LCDs.

2. Description of the Related Art

The light that lights up our world and allows us to see comes from solar energy in what is known as the visible region of the solar, electromagnetic, spectrum. This region is a very narrow segment of the total spectrum, the visible region being that portion visible to the human eye. It ranges in wavelength from about 440 nm in the extreme blue or near ultraviolet to about 690 nm in the red or near infrared. The middle of the visible region is a green color at about 555 nm. Human vision is such that what appears as white light is really composed of weighted amounts of a continuum of so-called black body radiation. In order to produce light that appears “white” to a human observer, the light needs to have component weights of about 30 percent in the red (R), 59 percent in the green (G) and 11 percent in the blue (B).

The perception of light as being white can be maintained even when the amount of one of the RGB component colors is changed, as long as the amounts of the other two can be adjusted to compensate. For example, if the red light source is shifted to a longer wavelength, the white light will appear more cyan in color if the other two colors remain unchanged. White balance may be restored, however, by changing the weight of the green and blue to levels other than their original values of 11 and 59 percent, respectively. The human eye does not have the ability to resolve closely spaced colors into the individual red, green, and blue (RGB) primary components of white light, since the human vision system mixes these three components to form intermediates. The reader probably recalls that human vision registers (and/or detects) only the three primary colors, and all other colors are perceived as combinations of these primaries.

Color liquid crystal displays (LCDs) in use today are based on picture elements, or “pixels,” formed by a matrix/array of liquid crystal (LC) cells. As is known the intensity of the light passing through a LC can be controlled by changing the angle of polarization of the light in response to an electrical field, voltage, applied across the LC. For a color LCD each pixel is actually composed of three “sub-pixels”: one red, one green, and one blue. Taken together, this sub-pixel triplet makes up what is referred to as a single pixel. What the human eye perceives as a single white pixel is actually a triplet of RGB sub-pixels with weighted intensities such that each of the three sub-pixels appears to have the same brightness. Likewise, when the human eye sees a solid white line, what is actually being displayed is a series or line of RGB triplets. The multi-sub-pixel arrangement may be manipulated by tuning the photometric output of the light source to a set of desired color coordinates, thereby offering a superior color rendering index (CRI) and a dynamic color selection for a large color palette.

In current color, transmissive LCD technology, this color tuning is implemented with the use of color filters. The principle of operation of a conventional color, transmissive LCD is based upon a bright white light backlighting source located behind a liquid crystal (LC) matrix, and a panel of color filters positioned on an opposite side of the liquid crystal matrix. The liquid crystal matrix is digitally switched to adjust the intensity of the white light from the backlighting source reaching each of the color filters of each pixel, thereby controlling the amount of colored light transmitted by the RGB sub-pixels. Light exiting the color filters generates the color image.

A typical LCD structure is sandwich-like in which the liquid crystal is provided between two glass panels; one glass panel containing the switching elements that control the voltage being applied across electrodes of the LC corresponding to respective sub-pixel, and the other glass panel containing the color filters. The switching elements for controlling the LC matrix which are located on the back of the structure, that is facing the backlighting source; typically comprise an array of thin film transistors (TFTs) in which a respective TFT is provided for each sub-pixel. The color filter glass panel is a glass plate with a set of primary (red, green, and blue) color filters grouped together Light exits the color filter glass panel to form the image.

As is known LCs have the property of rotating the plane of polarization of light as a function of the applied electric field, voltage. Through the use of polarizing filters and by controlling the degree of rotation of the polarization of the light as a function of the voltage applied across the LC the amount of white light supplied by the backlighting source to the filters is controlled for each red, green and blue sub-pixel. The light transmitted through the filters generates a range of colors for producing images that viewers see on a TV screen or computer monitor

Typically, the white light source used for backlighting comprises a mercury-filled cold cathode fluorescent lamp (CCFL). CCFL tubes are typically glass, and filled with inert gases. The gases ionize when a voltage is applied across electrodes positioned within the tube, and the ionized gas produces ultraviolet (UV) light. In turn, the UV light excites one or more phosphors coated on the inside of the glass tube, generating visible light. Reflectors redirect the visible light to the monitor and spread it as uniformly as possible, backlighting the thin, flat LCD. The backlight itself has always defined the color temperature and color space available, which has typically been approximately 75 percent of NTSC (National Television Standards Committee) requirements.

In the known LCD systems, the color filter is a key component for sharpening the color of the LCD. The color filter of a thin film transistor liquid crystal display (TFT LCD) consists of three primary colors (RGB) which are included on a color filter plate. The structure of the color filter plate comprises a black (opaque) matrix and a resin film, the resin film containing three primary-color dyes or pigments. The elements of the color filter line up in one-to-one correspondence with the unit pixels on the TFT-arrayed glass plate. Since the sub-pixels in a unit pixel are too small to be distinguished independently, the RGB elements appear to the human eye as a mixture of the three colors. As a result, any color, with some qualifications, can be produced by mixing these three primary colors.

The development over recent years of high brightness light emitting diodes (LEDs) has made possible LED backlighting with an enhanced color spectrum and has been used to provide a wider range of spectral colors for displays. In addition, LED backlighting has allowed for a tuning of the white point, when allied with a feedback sensor, ensuring the display operates consistently to a pre-defined performance.

In these LED based backlighting systems the light output from red, green and blue (RGB) LEDs is mixed in equal proportions to create white light. This approach unfortunately requires complex driving circuitry to properly control the intensities of the three different color LEDs since different circuitry is necessary because each of the LEDs demands different drive conditions.

An alternative approach has been to use a white emitting LED which comprises a single blue LED chip coated with a yellow fluorescent phosphor; the yellow phosphor absorbing a proportion of the blue light emitted by the blue LED, and then re-emitting that light (in a process known as down-conversion) as yellow light. By mixing the yellow light generated by the yellow phosphor with the blue light from the blue LED, white light over the entire visible spectrum could be produced. Alternatively, an ultraviolet LED can be coated with a red-green-blue phosphor to produce white light; in this case, the energy from the ultraviolet LED is substantially non-visible, and since it cannot contribute a component to the resultant white light, it functions only as an excitation source for the phosphors. Unfortunately the white light product of such LEDs does not match well with the color filters used in current LCDs, and a significant amount of the backlight intensity is wasted.

U.S. Pat. No. 4,830,469 proposes a LCD which uses UV light to excite red, green and blue light emitting phosphor pixels thereby eliminating the need for RGB color filters. Such LCDs are referred to as photo-luminescence color LCDs. A mercury lamp emitting UV light of wavelength 360 to 370 nm is used as a backlight and the red, green and blue emitting phosphors are provided on a front substrate plate. The UV light after being modulated by the liquid crystal matrix is then incident on the phosphor sub-pixels of the front plate which emit red, green and blue light in response.

U.S. Pat. 6,844,903 teaches a color, transmissive LCD which supplies a uniform blue light of wavelength 460 nm to the back of the liquid crystal layer The blue light, after being modulated by the liquid crystal layer, is then incident on the back surface of phosphor material located above the liquid crystal layer A first phosphor material, when irradiated with the blue light, generates red light for the red pixel areas of the display, and a second phosphor material, when irradiated with the blue light, generates green light for the green pixel areas of the display. No phosphor material is deposited over the blue pixel areas since blue light is provided from the backlight. A suitable diffuser (e.g. scattering powder) can be located at the blue sub-pixel areas so that the blue pixels match the viewing angle properties of the red and green pixels.

U.S. 2006/0238103 and U.S. 2006/0244367 teach photo-luminescence color LCDs which respectively use UV light of wavelength 360 to 460 nm and a near blue-UV light of wavelength 390 to 410 nm to excite red, green and blue light emitting phosphor pixels. The use of near blue-UV backlighting reduces deterioration of liquid crystals caused by UV light.

A further example of a photo-luminescence color LCD is disclosed in JP 2004094039.

The present invention concerns photo-luminescence color LCDs which utilize a phosphor material to generate the different colors of light of the sub-pixels. What is needed in the art is an LCD display that uses an RGB phosphor-based color rendering scheme to sharpen the color and enhance the brightness of the image.

### SUMMARY OF THE INVENTION

Embodiments of the present invention are directed to low-cost, high energy conversion efficiency color LCDs having enhanced color rendering. A LCD in accordance with the invention enables images with a high brightness and a spectacular, vivid range of colors to be realized. Such enhanced LCDs have applications in a variety of electronics devices including, but not limited to, televisions, monitors and computer monitors, the view screens of satellite navigation systems and hand-held devices such as mobile telephones and personal video/music systems.

In the most general configuration, a display system of the present embodiments comprises a red-green (RG) or red-green-blue (RGB) phosphor panel for generating the image to be displayed; and a substantially monochromatic short-wavelength light source for exciting the phosphors of the phosphor panel.

According to the invention there is provided a photo-luminescence color liquid crystal display comprising: a display panel and a radiation source for generating excitation radiation for operating the display; wherein the display panel comprises transparent front and back plates; a liquid crystal disposed between the front and back plates; a matrix of electrodes defining red, green and blue pixel areas of the display and operable to selectively induce an electric field across the liquid crystal in the pixel areas for controlling transmission of light through the pixel areas; a red phosphor material which emits red light in response to excitation radiation, the red phosphor material being provided on the back plate corresponding to red pixel areas and a green phosphor material which emits green light in response to excitation radiation, the green phosphor material being provided on the back plate corresponding to green pixel areas.

The radiation source may be either a blue-emitting LED with an excitation wavelength ranging from about 400 to about 480 nm, or a UV LED with an excitation wavelength ranging from about 360 to 400 nm. The radiation source may also comprise a UV emission line generated by a mercury (Hg) plasma discharge (the plasma may also come from an inert gas such as Xe or Ne) as the backlighting source, and the UV emission line may be centered about 254 nm. Alternatively, the excitation source may have a wavelength with the range 147 to 190 nm.

In general, the excitation source may be classified into one of two groups: 1) that having a wavelength ranging from about 200 to about 430 nm, and 2) that having a wavelength ranging from about 430 to 480 nm. In any event, these may be called short-wavelength backlighting sources.

When the excitation source is operable to emit UV excitation radiation the LCD further comprises a blue phosphor material which emits blue light in response to excitation radiation, the blue phosphor material being provided on the back plate corresponding to blue pixel areas.

The matrix of electrodes can comprise an array of thin film transistors (TFTs), one thin film transistor corresponding to each pixel. The TFTs can be provided on the front or back plates of the display.

The phosphor materials can be provided on lower or upper faces of the back plate.

The LCD can further comprise a first polarizing filter layer on the front plate and a second polarizing filter layer on the back plate and wherein the orientation of the direction of polarization of the first polarizing filter layer is perpendicular to the direction of polarization of the second polarizing filter layer

In one arrangement the radiation source can be an LED that emits blue light having a wavelength in a range of 400 to 480 nm. For such a radiation source the red phosphor can comprise: (Sr,Ba,Mg,Al)₃SiO₅:Eu,F; SrSi₅₋ₓAlₓOₓN₈₋ₓ:Eu; (Sr,Ba,Ca)₂Si₅N₈:Eu; SrS:Eu or Sr₂S₁₅N₈:Eu. The green phosphor advantageously comprises: (Sr,Ba,Mg)₂SiO₄:Eu,F; (Sr,Ba,Ca)₂Si₅N₈:Eu; SrSi₂N₂O₂:Eu; Y₃Al₅O₁₂:Ce or SrGa₂S₄:Eu.

In an alternative arrangement the radiation source comprises a UV LED that emits UV light having a wavelength in a range 360 to 400 nm. Preferably, the red phosphor comprises: (Sr,Ba,Mg,Al)₃SiO₅:Eu²⁺,F; Ca₂NaMg₂V₃O₁₂:Eu³⁺; YVO₄:Eu; (Sr,Ba,Ca)₂Si₅N₈:Eu; or Sr₂Si₅N₈:Eu. Advantageously, the green phosphor comprises: (Sr,Ba,Mg)₂SiO₄:Eu²⁺,F; (Ba,Eu)(Mg,Mn)Al₁₀O₁₇;Na₂Gd₂B₂O₇:Ce; Na₂Gd₂(BO₃)₂O:Tb or (Sr,Ba,Ca)₂Si₅N₈:Eu. The blue phosphor preferably comprises: BaMgAl₁₀O₁₇:Eu; (Sr,Ca,Ba,Mg)₁₀(PO₄)₆Cl₂:Eu; (Ba,Sr,Eu)(Mg,Mn)Al₁₀O₁₇; Sr₁₀(PO₄)₆Cl₂:Eu or (Ba,Eu)MgAl₁₀O₁₇.

In one further arrangement the radiation source is operable to emit UV light having a wavelength of order 254 nm. Advantageously, the red phosphor then comprises Y₂O₃:Eu; YVO₄:Eu; (Sr,Ba,Ca)₂Si₅N₈:Eu; or Sr₂Si₅N₈:Eu. The green phosphor preferably comprises: LaPO₄:Ce,Tb; (Ce, Tb)(Mg)Al₁₁O₁₉; (Ba,Eu)(Mg,Mn)Al₁₀O₁₇; or (Sr,Ba,Ca)₂Si₅N₈:Eu.

The blue phosphor can comprise: (SrCaBaMg)₅(PO₄)₃Cl:Eu; (Ba,Eu)Mg₂Al₁₆O₂₇; (Ba,Sr,Eu)(Mg,Mn)Al₁₀O₁₇; Sr₁₀(PO₄)₆Cl₂:Eu or (Ba,Eu)MgAl₁₀O₁₇.

In a yet further arrangement the radiation source comprises a plasma that emits UV light of wavelength 147 to 190 nm. An example of suitable plasma is that used is a plasma display panel (PDP). For such a radiation source the red phosphor preferably has a formula (Y,Gd)BO₃:Eu. The green phosphor preferably comprises Zn₂SiO₄:Mn or Ba_{0.6}Al₂O₃:Mn and the blue phosphor comprises BaMgAl₁₀O₁₇:Eu or BaMg₂Al₁₆O₂₇:Eu.

The current LCD technology that employs color filters has only about a 10 to 20 percent efficiency of light output that is achievable at the front of a liquid crystal display. By contrast, the present embodiments using a phosphor-based color rendering scheme, including using red-green phosphor elements plus blue LED illumination, can have up to 90 percent efficiency of light output. With a broader color range, phosphors and LED backlight together render truer skin tones and vivid reds and greens, offering better contrast ratios, purity and realism, and meeting new consumer expectations.

It is also considered inventive in its own right to use the phosphor compositions described in a LCD to generate light corresponding to the red, green and/or blue pixels irrespective of whether the phosphor material is provided on the front or back plates of the display panel. Thus according to a further aspect of the invention a photo-luminescence color liquid crystal display comprises: a display panel and a radiation source for generating excitation radiation for operating the display; wherein the display panel comprises transparent front and back plates; a liquid crystal disposed between the front and back plates; a matrix of electrodes defining red, green and blue pixel areas of the display and operable to selectively induce an electric field across the liquid crystal in the pixel areas for controlling transmission of light through the pixels areas; a red phosphor material corresponding to red pixel areas which emits red light in response to excitation radiation and a green phosphor material corresponding to green pixel areas which emits green light in response to excitation radiation, wherein the red phosphor is selected from the group consisting of: (Sr,Ba,Mg,Al)₃SiO₅:Eu,F; SrSi₅₋ₓAlₓOₓN₈₋ₓ:Eu; (Sr,Ba,Ca)₂Si₅N₈:Eu; SrS:Eu; Sr₂Si₅N₈:Eu; Ca₂NaMg₂V₃O₁₂:Eu³⁺; YVO₄:Eu; Y₂O₃:Eu and (YGd)BO₃:Eu.

According to a further aspect a photo-luminescence color liquid crystal display comprises: a display panel and a radiation source for generating excitation radiation for operating the display; wherein the display panel comprises transparent front and back plates; a liquid crystal disposed between the front and back plates; a matrix of electrodes defining red, green and blue pixel areas of the display and operable to selectively induce an electric field across the liquid crystal in the pixel areas for controlling transmission of light through the pixels areas; a red phosphor material corresponding to red pixel areas which emits red light in response to excitation radiation and a green phosphor material corresponding to green pixel areas which emits green light in response to excitation radiation, wherein the green phosphor is selected from the group consisting of: (Sr,Ba,Mg)₂SiO₄:Eu,F; (Sr,Ba,Ca)₂Si₅N₈:Eu; SrSi₂N₂O₂:Eu; Y₃Al₅O₁₂:Ce; SrGa₂S₄:Eu; (Ba,Eu)(Mg,Mn)Al₁₀O₁₇; Na₂Gd₂B₂O₇:Ce; Na₂Gd₂(BO₃)₂O:Tb; (Sr,Ba,Ca)₂Si₅Ng:Eu; LaPO₄:Ce,Tb; (Ce,Tb)MgA₁₁O₁₉; Zn₂SiO₄:Mn; and Ba_{0.6}Al₂O₃:Mn.

According to a yet further aspect of the invention the liquid crystal display further comprises a blue phosphor material corresponding to blue pixel areas which emits blue light in response to excitation radiation, wherein the blue phosphor is selected from the group consisting of: BaMgAl₁₀O₁₇:Eu; (Sr,Ca,Ba,Mg)₁₀(PO4)₆Cl₂:Eu; (Ba,Sr,Eu)(Mg,Mn)Al₁₀O₁₇; Sr₁₀(PO₄)₆Cl₂:Eu; (Ba,Eu)MgAl₁₀O₁₇; (SrCaBaMg)₅(PO₄)₃Cl:Eu; BaMgAl₁₀O₁₇:Eu; and BaMg₂Al₁₆O₂₇:Eu.

### BRIEF DESCRIPTION OF THE DRAWINGS

In order that the present invention is better understood embodiments of the invention will now be described, by way of example only, with reference to the accompanying drawings in which:

FIG. 1 is a schematic cross-sectional representation of a photo-luminescence color LCD according to the invention;

FIG. 2a is a schematic diagram of a unit pixel of a phosphor color-elements plate of the display of FIG. 1;

FIG. 2b is a schematic diagram of a unit pixel of a phosphor color-elements plate of the display of FIG. 3;

FIG. 3 is a schematic cross-sectional representation of an alternative embodiment of the configuration shown in FIG. 1;

FIG. 4 shows schematic normalized emission spectra for red, green, and blue light generated by UV and blue light excited phosphors;

FIG. 5 is a schematic cross-sectional representation of a further photo-luminescence color LCD in accordance with the invention which is backlit by blue light; and

FIG. 6 is a schematic cross-sectional representation of another photo-luminescent color LCD in accordance with the invention which is backlit by a UV plasma discharge.

### DETAILED DESCRIPTION OF THE INVENTION

Disclosed herein is a novel color rendering scheme designed to improve and enhance the brightness and sharpness of an electronic display, such as a liquid crystal display (LCD). Embodiments of the present invention incorporate two key components: 1) a red-green (RG) or red-green-blue (RGB) phosphor panel, and 2) a monochromatic (or at least a substantially monochromatic) short-wavelength light source for exciting the RGB phosphors of the RG phosphor panel. These components replace the color-filter panel and the broadband white light source, respectively, which have been traditionally used in prior art LCDs.

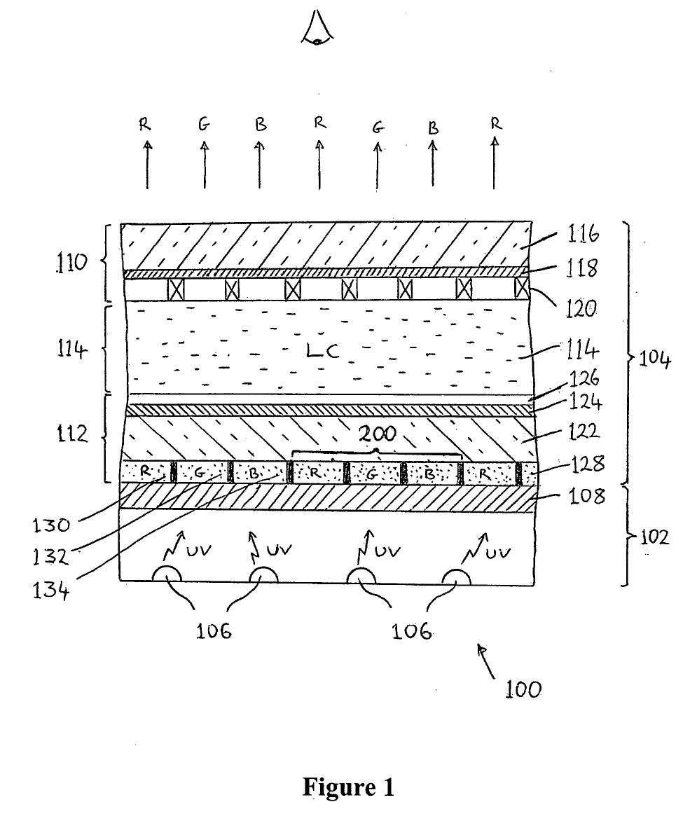

Referring to FIG. 1 there is shown a schematic cross-sectional representation of a photo-luminescence color LCD 100 according to a first embodiment of the invention. The LCD 100 comprises a display panel 104 and a backlighting unit 102.

The backlighting unit 102 comprises either a single excitation radiation source or a plurality of sources 106 and a light diffusing plane 108. Each radiation source 106 may be substantially monochromatic that is operable to emit excitation radiation of a narrow wavelength range/color. In the arrangement of FIG. 1 the, or each, excitation source 106 comprises a UV emitting LED (wavelength range 360 to 400 nm), a UV emitting lamp (254 nm), plasma discharge (147 to 190 nm) or light sources such as UV discharges of inert gas filled arc lamps. The light diffusing plane 108 ensures the display panel 104 is substantially evenly irradiated with excitation radiation over its entire surface.

The display panel 104 comprises a transparent front (light/image emitting) plate 110, a transparent back plate 112 and a liquid crystal (LC) 114 filling the volume between the front and back plates. The front plate 110 comprises a glass plate 116 having on its underside, that is the face of the plate facing the LC 114, a first polarizing filter layer 118 and then a thin film transistor (TFT) layer 120. The back plate 112 comprises a glass plate 122 having a second polarizing filter layer 124 and a transparent common electrode plane 126 (for example transparent indium tin oxide, ITO) on its upper surface facing the LC and a phosphor color-elements plate 128 on its underside facing the backlighting unit 102. As will be described the phosphor color-elements plate 128 comprises an array of different phosphors 130, 132, 134 which emit red (R), green (G), and blue (B) light respectively in response to UV excitation radiation from the backlighting unit 102. The TFT layer 120 comprises an array of TFTs, wherein there is a corresponding transistor to each individual color phosphor sub-pixel 130, 132, 134 of each pixel unit 200 of the phosphor color-elements plate 128. As is known, the directions of polarization of the two polarizing filters 118, 124 are aligned perpendicular to one another

The RGB phosphors 130, 132, 134 function in such a manner that the result is similar to that which the color filters of prior art LCD devices achieve, each RGB pixel being capable of producing a range of colors. The difference between the prior art color filters and the presently disclosed RGB phosphors is that color filters only allow certain wavelengths of light to pass through them, whereas phosphors generate a selected wavelength (color) of light in response to excitation by UV radiation from the backlighting unit. Stated another way, color filters allow only light within a certain range of wavelengths to be transmitted, whereas the RBG phosphors emit light of different colors, with a certain spectral width centered at a peak wavelength.

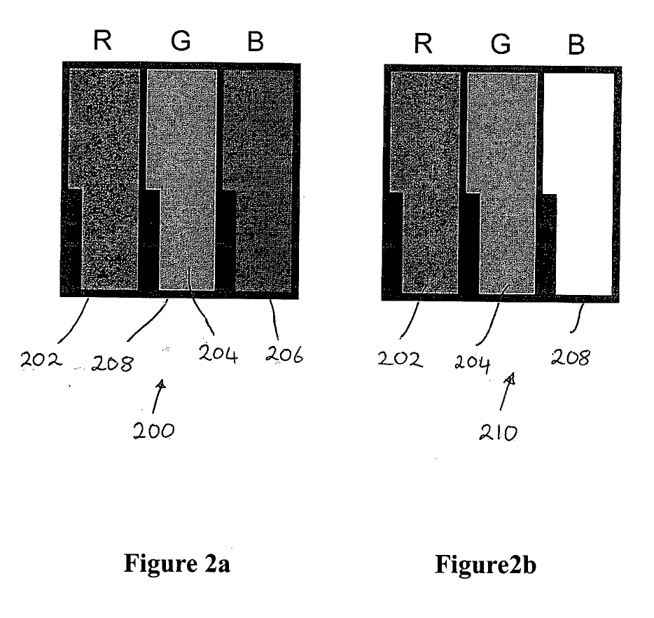

The RGB phosphors can be packaged/configured on the color plate 128 in a manner similar to the way in which the color filters of the prior art displays are configured. This is illustrated in FIG. 2a which shows a unit pixel 200 of the phosphor color-element plate 128 comprising a sub-pixel triplet filled by three phosphors 202, 204, 206 with emissions centered at the primary red (R), green (G), and blue (B) colors for UV excited phosphors. A grid mask (also termed a black matrix) 208 of metal, such as for example chromium, defines the phosphor color blocks 202, 204, 206 and provides an opaque gap between the phosphor sub-pixels and unit pixels. Additionally the black matrix shields the TFTs from stray light and prevents crosstalk between neighboring sub-pixels/unit pixels. To minimize reflection from the black matrix 208, a double layer of Cr and CrOx may be used, but of course, the layers may comprise materials other than Cr and CrOx. The black matrix film which can be sputter-deposited underlying or overlying the phosphor material may be patterned using methods that include photolithography.

There are a variety of ways in which the RGB phosphors can be incorporated into/onto the glass plate 122. Typically, most phosphor materials are hard substances, and the individual particles may have a variety of irregular shapes. It can be difficult to incorporate them directly into plastic resins, however, phosphors are known to be compatible with acrylic resins, polyesters, epoxies, polymers such as polypropylene and high and low density polyethylene (HDPE, LDPE) polymers. Materials may be sprayed, cast, dipped, coated, extruded or molded. In some embodiments it may be preferable to use master batches for incorporating the phosphor-containing materials into clear plastics, which may then be coated onto the glass plate 122. In reality, any of the methods that are used for fabricating plasma display panels having RGB phosphor-containing pixel matrices, such methods being screen printing, photolithography, and ink printing techniques, may also be used to fabricate the present phosphor color plate 128.

There are a variety of compositions available for the red, green, and blue phosphors of the RGB phosphor color-element plate 128. The host material is typically an oxide, and may comprise an aluminate, silicate, phosphate or borate, but the host material is not restricted to these classes of compounds. The red, green, and blue phosphors, for example, may comprise an aluminate, a silicate, a sulfate, an oxide, a chloride, a fluoride, and/or a nitride, doped with a rare-earth element called an activator The activator may include divalent europium, but the activator is not limited to divalent europium. Dopants such as halogens can be substitutionally or interstitially incorporated into the crystal lattice and can for example reside on oxygen lattice sites of the host material and/or interstitially within the host material. Examples of suitable phosphor composition along with the range of wavelengths at which they may be excited is given in Table 1.

An advantage of the LCD of the present invention is a prolonged life of the LC since the phosphor color-element plate is situated on the backlighting unit side of the LC and provided the phosphor color-element plate absorbs substantially all of the UV activation light, this prevents UV light reaching the LC and causing degradation. Placing the excitation light source next to the phosphor coated color panel enhances the quantum efficiency of the display panel if the UV absorption of the liquid crystal material severely attenuates the excitation intensity.

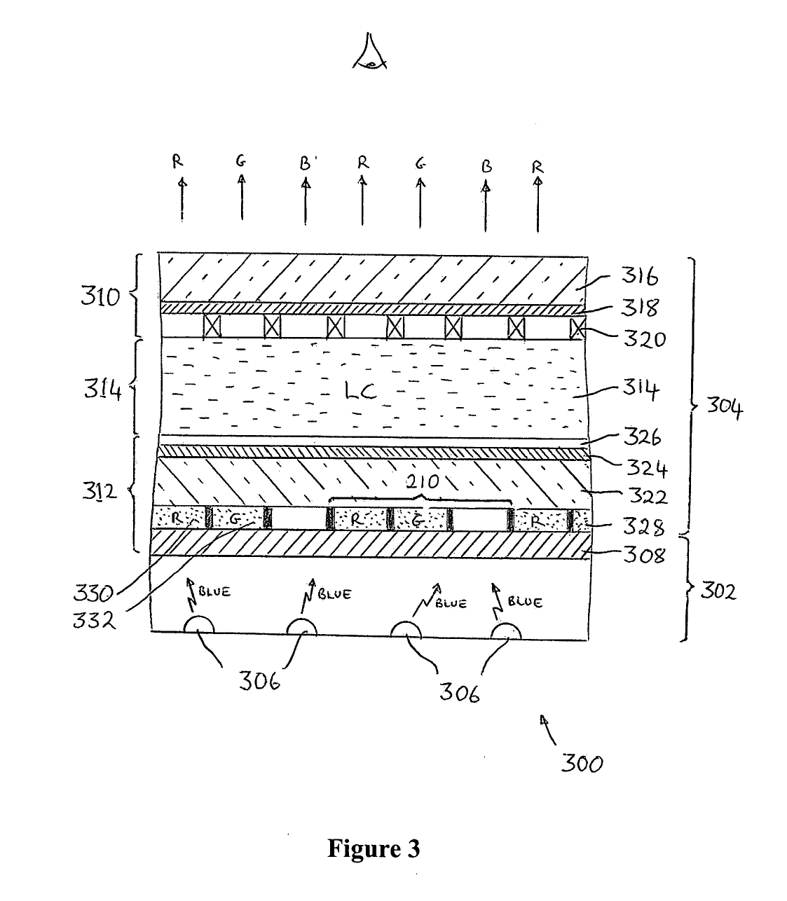

FIG. 3 illustrates an alternative color LCD 300 in accordance with the invention which uses blue light (400 to 480 nm) activated phosphors. Throughout this specification like reference numerals preceded by the figure number are used to denote like parts. For example the LC 114 of FIG. 1 is denoted 314 in FIG. 3. In contrast to the LCD 100 the backlighting unit 302 incorporates blue light emitting diodes (LEDs) 306 for exciting red and green phosphor sub-pixels 330, 332 respectively. FIG. 2b is a unit pixel 210 of the phosphor color-element plate 328. The unit pixel 210 includes two blue light excitable phosphors 202, 204 emitting red (R) and green (G) light respectively, and the third sub-pixel is left empty, that is without the inclusion of a phosphor, to allow the transmission of blue light from a blue emitting LED backlighting unit 302. In this case the, monochromatic backlighting unit 302 serves a dual purpose; firstly it generates blue excitation radiation to excite the red and green phosphors, and second, to provide the blue portion of the backlighting light.

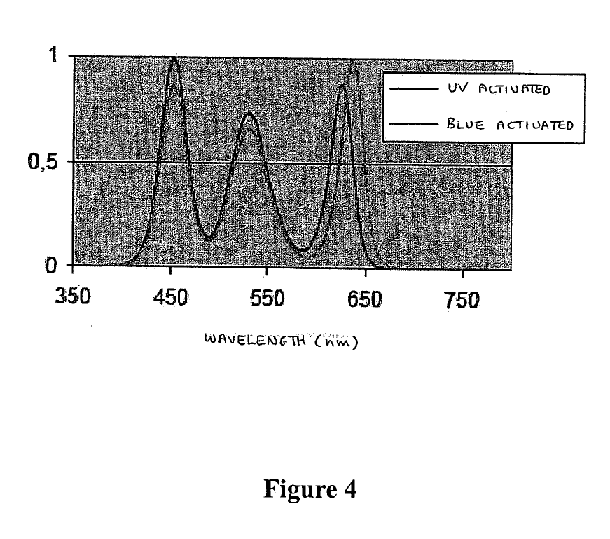

Exemplary emission spectra from red, green, and blue phosphors are shown schematically in FIG. 4. Exemplary monochromatic light sources (backlighting units) 102, 302 that would lead to such emission are ultraviolet (UV) light emitting diodes (LEDs), and single or multiple sharp line emissions from UV lamps such as, but not limited to, the 256 nm line from a mercury lamp.

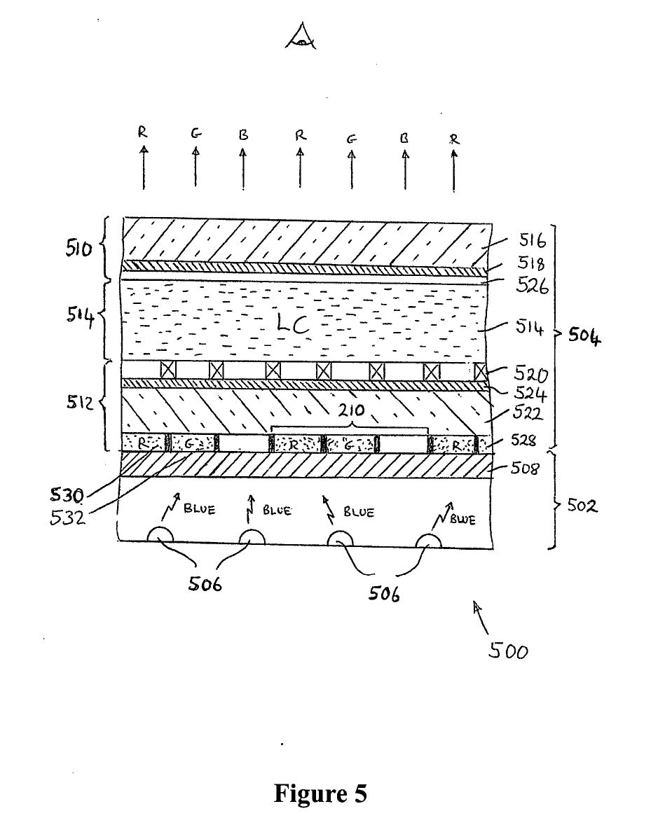

In a further embodiment, as illustrated in FIG. 5, the back plate 512 includes both the TFT plate 520 and phosphor color-element plate 528. In this arrangement the TFT plate 520 is provided on the second polarizing filter 524 on the upper surface of the glass plate 522 facing the LC, and the phosphor color plate 528 is provided on the opposite lower face of the glass plate. In the embodiment illustrated the backlighting unit 502 comprises a blue light excitation source and can comprise one or more blue emitting LEDs 506. As with the embodiment of FIG. 3 only red 530 and green 532 phosphor sub-pixels are incorporated in the phosphor color-element plate 528, the blue excitation light also serving as the third of the three primaries that are essential to color rendering.

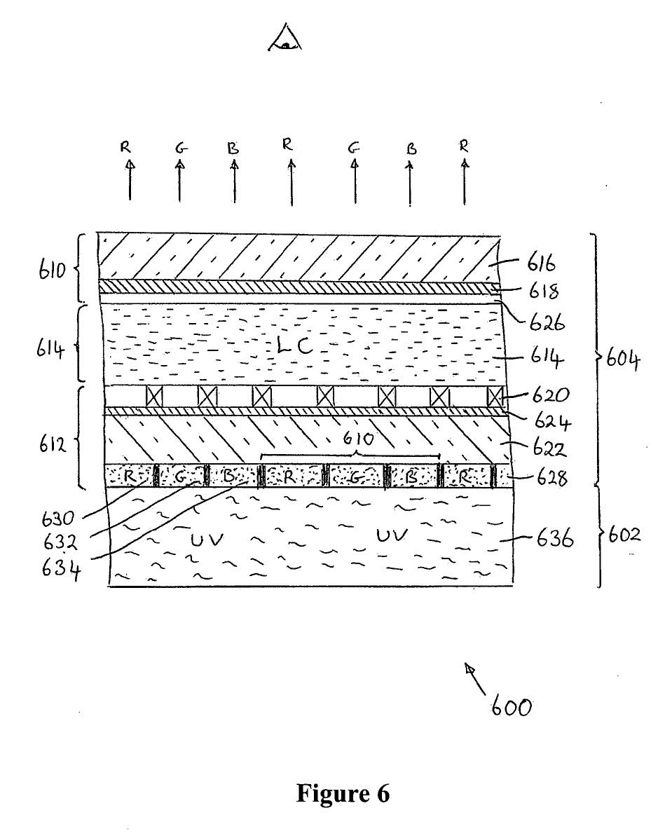

FIG. 6 illustrates an LCD 600 in accordance with a further embodiment of the invention. In FIG. 6, UV excitation irradiation is generated by a plasma discharge 636 of a gas such as Hg, Xe, or Ne, and the plasma 636 used to excite the RGB phosphors 630, 632, and 634 in a similar fashion to the way in which phosphor emission takes place in a plasma display panel (PDP). However, the difference between the embodiment illustrated in FIG. 6 and a PDP is that in the present embodiment there is only a single plasma source providing a collective excitation to all phosphor coloring elements. This is in contrast to plasma display technology, in which there are provided the same number of plasma sources as there are phosphor pixels, and where each individual phosphor pixel is excited by its own plasma source.

In further embodiments, not illustrated, the phosphor color plate can be provided as part of the front plate that is an on opposite side of the liquid crystal to the backlighting unit. In such an arrangement the TFTs plate can be provided on the front or back plates.

It will be appreciated that the present invention is not restricted to the specific embodiments described and that variations can be made that are within the scope of the invention. For example whilst for ease of fabrication the phosphor color-element plate can be fabricated on a lower side of the back plate, in other arrangements it can be provided on the upper surface of the back plate and the first polarizing filter provided on top of the color-element plate. Moreover, the use of the phosphor materials described in an LCD display is considered inventive in its own right. Thus in other embodiments of the invention the phosphor material can be provided on the front plate of the display.

LCDs in accordance with invention are expected to produce a spectacular, vivid range of colors rivaling plasma display panel (PDP) technology. It is known that color filters are a key component in LCDs for sharpening color, although they account for as much as 20 per cent of the manufacturing cost. Significant cost reduction is expected with the present embodiments, particularly when an array of blue LEDs is used to provide backlighting, because only two thirds of the pixel area need to be coated with a phosphor

In addition, LEDs are the preferred choices as backlighting excitation sources because they are expected to have longer lifetimes than other light sources. LEDs are more durable because there is no filament to bum out, no fragile glass tube to shatter, no moving parts to protect, and a cooler operating temperature. In fact, the lifespan of a LED is estimated to be twice as long as the best fluorescent bulbs. By adjusting the number and density of the LEDs, high brightness values can be achieved without significantly diminishing the life expectancy of the liquid crystal displays. Moreover, LEDs are more efficient with lower power consumption.

The demand for more efficient backlighting has been steadily increasing. The current LCD technology that employs color filters has only about a 10 to 20 percent efficiency of light output that is achievable at the front of a liquid crystal display. By contrast, the present embodiments using an RGB phosphor-based color rendering scheme, including using red-green phosphor elements plus blue LED illumination, can have up to 90 percent efficiency of light output. Moreover, television sets having liquid crystal displays with phosphor pixels might also provide very wide horizontal and vertical viewing angles.

TABLE 1
Chemical formulae of phosphor compositions for different excitation sources.

| Excitation | Excitation | | Phosphor Composition | | |
|---|---|---|---|---|---|
| Source | wavelength | | Blue | Green | Red |
| Blue LED | 400~480 | nm | — | (Sr,Ba,Mg)₂SiO₄:Eu,F | (Sr,Ba,Mg,Al)₃SiO₅:Eu,F |
| | | | | (Sr,Ba,Ca)₂Si₅N₈:Eu | SrSi₅₋ₓAlₓOₓN₈₋ₓ:Eu |
| | | | | SrSi₂N₂O₂:Eu | (Sr,Ba,Ca)₂Si₅N₈:Eu |
| | | | | Y₃Al₅O₁₂:Ce | SrS:Eu |
| | | | | SrGa₂S₄:Eu | Sr₂Si₅N₈:Eu |
| UV LED | 360~400 | nm | BaMgAl₁₀O₁₇:Eu | (Sr,Ba,Mg)₂SiO₄:Eu,F | (Sr,Ba,Mg,Al)₃SiO₅:Eu,F |
| | | | (Sr,Ca,Ba,Mg)₁₀(PO₄)₆Cl₂:Eu | (Ba,Eu)(Mg,Mn)Al₁₀O₁₇ | Ca₂NaMg₂V₃O₁₂:Eu³⁺ |
| | | | (Ba,Sr,Eu)(Mg,Mn) | Na₂Gd₂B₂O₇:Ce | YVO₄:Eu |
| | | | Al₁₀O₁₇ | Na₂Gd₂(BO₃)₂O:Tb | (Sr,Ba,Ca)₂Si₅N₈:Eu |
| | | | Sr₁₀(PO₄)₆Cl₂:Eu | (Sr,Ba,Ca)₂Si₅N₈:Eu | Sr₂Si₅N₈:Eu |
| | | | (Ba,Eu)MgAl₁₀O₁₇ | | |
| UV | 254 | nm | (SrCaBaMg)₅(PO₄)₃ | LaPO₄:Ce,Tb | Y₂O₃:Eu |
| | | | Cl:Eu | (Ce,Tb)MgAl₁₁O₁₉ | YVO₄:Eu |
| | | | (Ba,Eu) | (Ba,Eu)(Mg,Mn)Al₁₀O₁₇ | (Sr,Ba,Ca)₂Si₅N₈:Eu |
| | | | Mg₂Al₁₆O₂₇ | (Sr,Ba,Ca)₂Si₅N₈:Eu | Sr₂Si₅N₈:Eu |
| | | | (Ba,Sr,Eu)(Mg,Mn) | | |
| | | | Al₁₀O₁₇ | | |
| | | | Sr₁₀(PO₄)₆Cl₂:Eu | | |
| | | | (Ba,Eu)MgAl₁₀O₁₇ | | |
| PDP | 147~190 | nm | BaMgAl₁₀O₁₇:Eu | Zn₂SiO₄:Mn | (Y,Gd)BO₃:Eu |
| | | | BaMg₂Al₁₆O₂₇:Eu | Ba_{0.6}Al₂O₃:Mn | |

What is claimed is:

1. A photo-luminescence color liquid crystal display comprising: a display panel and a radiation source for generating excitation radiation for operating the display; wherein the display panel comprises transparent front and back plates; a liquid crystal disposed between the front and back plates; a matrix of electrodes defining red, green and blue pixel areas of the display and operable to selectively induce an electric field across the liquid crystal in the pixel areas for controlling transmission of light through the pixels areas; a red phosphor material which emits red light in response to excitation radiation, the red phosphor material being provided on the back plate corresponding to red pixel areas and a green phosphor material which emits green light in response to excitation radiation, the green phosphor material being provided on the back plate corresponding to green pixel areas.

2. The display of claim 1, and further comprising a blue phosphor material which emits blue light in response to excitation radiation, the blue phosphor material being provided on the back plate corresponding to blue pixel areas.

3. The display of claim 1, wherein the matrix of electrodes comprises an array of thin film transistors, one thin film transistor corresponding to each pixel.

4. The display of claim 3, wherein the thin film transistors are provided on the front plate.

5. The display of claim 3, wherein the thin film transistors are provided on the back plate.

6. The display of claim 1, wherein the phosphor materials are provided on a lower face of the back plate.

7. The display of claim 2, wherein the phosphor materials are provided on a lower face of the back plate.

8. The display of claim 1, wherein the phosphor materials are provided on an upper face of the back plate.

9. The display of claim 2, wherein the phosphor materials are provided on an upper face of the back plate.

10. The display of claim 1, further comprising a first polarizing filter layer on the front plate and a second polarizing filter layer on the back plate and wherein the orientation of the direction of polarization of the first polarizing filter layer is perpendicular to the direction of polarization of the second polarizing filter layer

11. The display of claim 1, wherein the red phosphor is selected from the group consisting of: (Sr,Ba,Mg,Al)₃SiO₅:Eu,F; SrSi₅₋ₓAlₓOₓN₈₋ₓ:Eu; (Sr,Ba,Ca)₂Si₅N₈:Eu; SrS:Eu; and Sr₂Si₅N₈:Eu.

12. The display of claim 11, wherein the radiation source is a light emitting diode that emits blue light having a wavelength in a range of 400 to 480 nm.

13. The display of claim 1, wherein the green phosphor is selected from the group consisting of: (Sr,Ba,Mg)₂SiO₄:Eu,F; (Sr,Ba,Ca)₂Si₅N₈:Eu; SrSi₂N₂O₂:Eu; Y₃Al₅O₁₂:Ce; and SrGa₂S₄:Eu.

14. The display of claim 13, wherein the radiation source is a light emitting diode that emits blue light having a wavelength in a range of 400 to 480 nm.

15. The display of claim 2, wherein the red phosphor is selected from the group consisting of: (Sr,Ba,Mg,Al)₃SiO₅:Eu²⁺,F; Ca₂NaMg₂V₃O₁₂:Eu³⁺; YVO₄:Eu; (Sr,Ba,Ca)₂Si₅N₈:Eu; and Sr₂Si₅N₈:Eu.

16. The display of claims 15, wherein the radiation source is a UV emitting light emitting diode that emits light having a wavelength in a range 360 to 400 nm.

17. The display of claim 2, wherein the green phosphor is selected from the group consisting of: (Sr,Ba,Mg)₂SiO₄:Eu²⁺,F; (Ba,Eu)(Mg,Mn)Al₁₀O₁₇; Na₂Gd₂B₂O₇:Ce; Na₂Gd₂(BO₃)₂O:Tb; and (Sr,Ba,Ca)₂Si₅N₈:Eu.

18. The display of claims 17, wherein the radiation source is a UV emitting light emitting diode that emits light having a wavelength in a range 360 to 400 nm.

19. The display of claim 2, wherein the blue phosphor is selected from the group consisting of: BaMgAl₁₀O₁₇:Eu; (Sr,Ca,Ba,Mg)₁₀(PO₄)₆Cl₂:Eu; (Ba,Sr,Eu)(Mg,Mn)Al₁₀O₁₇; Sr₁₀(PO₄)₆Cl₂:Eu; and (Ba,Eu)MgAl₁₀O₇.

20. The display of claim 19, wherein the radiation source is a UV emitting light emitting diode that emits light having a wavelength in a range 360 to 400 nm.

21. The display of claim 2, wherein the red phosphor is selected from the group consisting of: Y₂O₃:Eu; YVO₄:Eu; (Sr,Ba,Ca)₂Si₅N₈:Eu; and Sr₂Si₅N₈:Eu.

22. The display of claim 21, wherein the excitation radiation comprises UV light having a wavelength of order 254 nm.

23. The display of claim 2, wherein the green phosphor is selected from the group consisting of: LaPO₄:Ce,Tb; (Ce,Tb)(Mg)Al₁₁O₁₉; (Ba,Eu)(Mg,Mn)Al₁₀O₁₇; and (Sr,Ba,Ca)₂Si₅N₈:Eu.

24. The display of claim 23, wherein the excitation radiation comprises UV light having a wavelength of order 254 nm.

25. The display of claim 2, wherein the blue phosphor is selected from the group consisting of: (SrCaBaMg)₅(PO₄)₃Cl:Eu; (Ba,Eu)Mg₂Al₁₆O₂₇; (Ba,Sr,Eu)(Mg,Mn)Al₁₀O₁₇; Sr₁₀(PO₄)₆Cl₂:Eu; and (Ba,Eu)MgAl₁₀O₁₇.

26. The display of claim 25, wherein the excitation radiation comprises UV light having a wavelength of order 254 nm.

27. The display of claim 2, wherein the red phosphor has a formula (Y,Gd)BO₃:Eu.

28. The display of claim 27, wherein and the radiation source is a plasma emitting light having a wavelength in a range 147 to 190 nm.

29. The display of claim 2, wherein the green phosphor is selected from the group consisting of: Zn₂SiO₄:Mn and Ba_{0.6}Al₂O₃:Mn.

30. The display of claim 29, wherein and the radiation source is a plasma emitting light having a wavelength in a range 147 to 190 nm

31. The display of claim 2, wherein the blue phosphor is selected from the group consisting of: BaMgAl₁₀O₁₇:Eu and BaMg₂Al₁₆O₂₇:Eu.

32. The display of claim 31, wherein and the radiation source is a plasma emitting light having a wavelength in a range 147 to 190 nm.

33. A photo-luminescence color liquid crystal display comprising: a display panel and a radiation source for generating excitation radiation for operating the display; wherein the display panel comprises transparent front and back plates; a liquid crystal disposed between the front and back plates; a matrix of electrodes defining red, green and blue pixel areas of the display and operable to selectively induce an electric field across the liquid crystal in the pixel areas for controlling transmission of light through the pixels areas; a red phosphor material corresponding to red pixel areas which emits red light in response to excitation radiation and a green phosphor material corresponding to green pixel areas which emits green light in response to excitation radiation, wherein the red phosphor is selected from the group consisting of: (Sr,Ba,Mg,Al)₃SiO₅:Eu,F; SrSi₅₋ₓAlₓOₓN₈₋ₓ:Eu; (Sr,Ba,Ca)₂Si₅N₈:Eu; SrS:Eu; Sr₂Si₅N₈:Eu; Ca₂NaMg₂V₃O₁₂:Eu³⁺; YVO₄:Eu; Y₂O₃:Eu and (Y,Gd)BO₃:Eu.

34. A photo-luminescence color liquid crystal display comprising: a display panel and a radiation source for generating excitation radiation for operating the display; wherein the display panel comprises transparent front and back plates; a liquid crystal disposed between the front and back plates; a matrix of electrodes defining red, green and blue pixel areas of the display and operable to selectively induce an electric field across the liquid crystal in the pixel areas for controlling transmission of light through the pixels areas; a red phosphor material corresponding to red pixel areas which emits red light in response to excitation radiation and a green phosphor material corresponding to green pixel areas which emits green light in response to excitation radiation, wherein the green phosphor is selected from the group consisting of: (Sr,Ba,Mg)₂SiO₄:Eu,F; (Sr,Ba,Ca)₂Si₅N₈:Eu; SrSi₂N₂O₂:Eu; Y₃Al₅O₁₂:Ce; SrGa₂S₄:Eu; (Ba,Eu)(Mg,Mn)Al₁₀O₁₇; Na₂Gd₂B₂O₇:Ce; Na₂Gd₂(BO₃)₂O:Tb; (Sr,Ba,Ca)₂Si₅N₈:Eu; LaPO₄:Ce,Tb; (Ce,Tb)MgAl₁₁O₁₉; Zn₂SiO₄:Mn; and Ba_{0.6}Al₂O₃:Mn.

35. The display of claim 34 and further comprising a blue phosphor material corresponding to blue pixel areas which emits blue light in response to excitation radiation, wherein the blue phosphor is selected from the group consisting of: BaMgAl₁₀O₁₇:Eu; (Sr,Ca,Ba,Mg)₁₀(PO4)₆Cl₂:Eu; (Ba,Sr,Eu)(Mg,Mn)Al₁₀O₁₇; Sr₁₀(PO₄)₆Cl₂:Eu; (Ba,Eu)MgAl₁₀O₁₇; (SrCaBaMg)₅(PO₄)₃Cl:Eu; BaMgAl₁₀O₁₇:Eu; and BaMg₂Al₁₆O₂₇:Eu.
